(19) United States
(12) Patent Application Publication
(10) Pub. No.: US 2026/0288182 A1
(43) Pub. Date: Sep. 24, 2026

(54) ADAPTIVE VOLTAGE REGULATOR

(71) Applicant: Advanced Micro Devices, Inc., Santa Clara, CA (US)

(72) Inventors: David L. Wigton, Liberty Hill, TX (US); Martin McAfee, Cedar Park, TX (US)

(73) Assignee: Advanced Micro Devices, Inc., Santa Clara, CA (US)

(21) Appl. No.: 19/083,285

(22) Filed: Mar. 18, 2025

(51) Int. Cl. G05F 1/575; G05F 1/565

(52) U.S. Cl. CPC G05F 1/575; G05F 1/565

(57) ABSTRACT

A system can include an integrated circuit; and an adaptive voltage regulator (AVR) device configured to provide a power supply signal having a regulated voltage to the integrated circuit. The AVR can include a slew rate control circuit configured to perform operations including adjusting a maximum slew rate of the regulated voltage based on an amplitude of a load current provided to the integrated circuit (IC). In some examples, the AVR improves the performance of the IC by responding rapidly to changes in the IC's target supply voltage when the load current is relatively low, while also limiting the occurrence of potentially harmful over-currents by lowering the slew rate of the regulated supply voltage when the load current is already relatively high.

### BACKGROUND

Voltage regulator (VR) devices regulate the voltage of an electrical signal (e.g., power supply signal). Switched mode voltage regulator devices (“switching regulators” or “switched mode regulators”) regulate the power supply voltage by switching one or more switches (e.g., transistors) on and off, with the duty cycles of the switches determining how much charge is transferred from the power supply to the load. Switching regulators can be highly efficient and are often used in computer systems. A VR having many phase circuits (PCs) may be referred to as a multi-phase VR.

### BRIEF DESCRIPTION OF THE FIGURES

The accompanying drawings illustrate a number of example implementations and are a part of the specification. Together with the following description, these drawings demonstrate and explain various principles of the present disclosure.

FIG. 1 is a block diagram of an example computer system with supply voltages of one or more components regulated by an example adaptive voltage regulator.

FIG. 2 is a block diagram of an example adaptive voltage regulator.

FIG. 3 shows a schematic of a phase circuit of an adaptive voltage regulator.

FIG. 4 is a flow diagram of an example adaptive voltage regulation method.

FIG. 5 is a diagram of adaptive slew rate values, according to an example.

FIG. 6 is a block diagram of a programmable processor implementing a slew rate control circuit 290, according to an example.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure describes an adaptive voltage regulator (AVR) configured to adjust the maximum slew rate of a regulated voltage provided by the AVR. In some examples, the AVR adjusts the maximum slew rate of the regulated voltage based on an amplitude of a load current provided by the AVR to a load (e.g., an integrated circuit). In some examples, the AVR improves the performance of the load by responding rapidly to changes in the load's target supply voltage when the load current is relatively low, while also avoiding (or limiting) the occurrence of potentially harmful over-currents by lowering the slew rate of the regulated supply voltage when the load current is already relatively high.

Many modern integrated circuits (e.g., processors) perform best when the supply voltage is adjusted based on the IC's real-time operating conditions. Failing to adapt (or slowly adapting) the supply voltage to a processor's operating conditions restricts processor performance (if the supply voltage is too low) or wastes power (if the supply voltage is too high). Thus, providing rapid changes in supply voltage can be beneficial. However, rapid changes in supply voltage can also lead to large spikes in load current, which can apply stress or cause damage to the power delivery network, the voltage regulator, or the load (e.g., integrated circuit, processor, etc.). One approach to avoiding damaging current spikes (“over-current”) is to minimize the voltage regulator's output capacitance, but this approach limits the voltage regulator's transient performance, making it difficult to rapidly change the supply voltage when the processor's operating conditions change rapidly. The present disclosure describes an alternative, adaptive solution. In some examples, the load current is monitored and the voltage regulator allows the supply voltage to change more rapidly when the load current is low and less rapidly when the load current is high. In this way, the voltage regulator is able to rapidly change the supply voltage over a wide range of operating conditions, without risking a damaging over-current when the load current is already near its maximum safe value. In some examples, the adaptive voltage regulator improves system performance (e.g., the performance of the voltage regulator's load) and/or reduces the stress on the voltage regulator, the power delivery network, and the load.

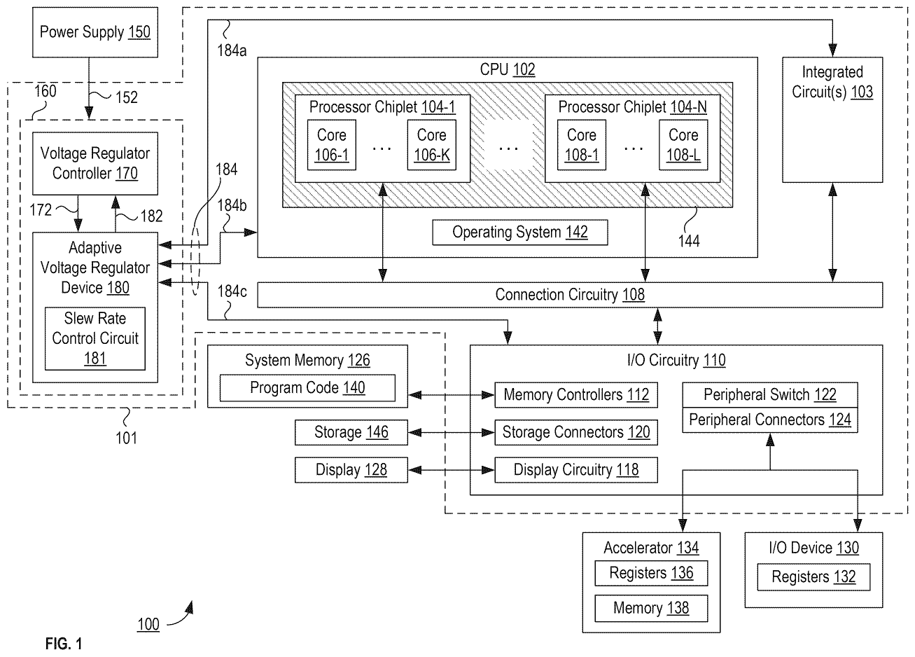

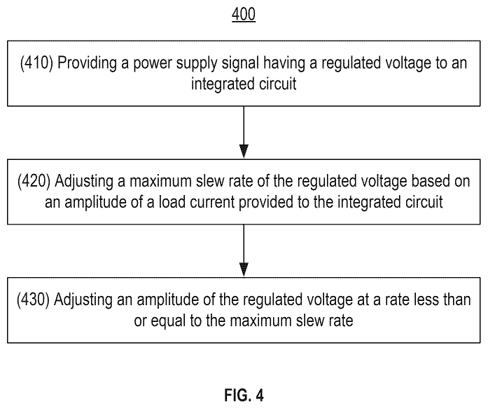

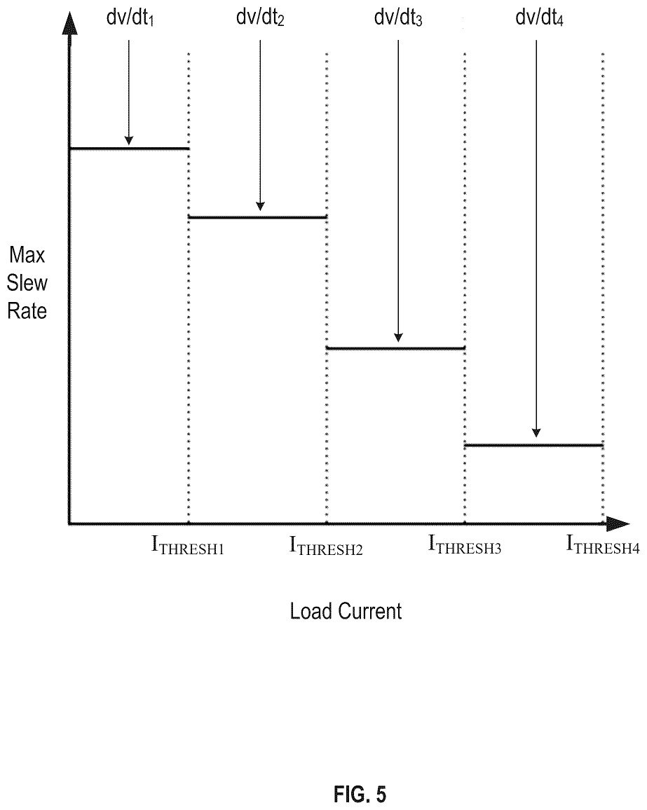

This disclosure provides, with reference to FIGS. 1-3 and 6, detailed descriptions of example adaptive voltage regulator devices and systems. Detailed descriptions of corresponding adaptive voltage regulator methods are provided in connection with FIGS. 4-5.

In some aspects, the techniques described herein relate to a system including: an integrated circuit; and a voltage regulator device configured to provide a power supply signal having a regulated voltage to the integrated circuit, wherein the voltage regulator device includes a slew rate control circuit configured to perform operations including adjusting a maximum slew rate of the regulated voltage based on an amplitude of a load current provided to the integrated circuit.

In some aspects, the techniques described herein relate to a system, wherein the integrated circuit is configured to send, to the voltage regulator device, a request indicating a target amplitude of the regulated voltage, and wherein the voltage regulator device is configured to respond to the request by adjusting the regulated voltage from a first amplitude to the target amplitude at a rate less than or equal to the maximum slew rate.

In some aspects, the techniques described herein relate to a system, wherein the integrated circuit includes a central processing unit (CPU), graphics processing unit (GPU), or accelerated processing unit (APU).

In some aspects, the techniques described herein relate to a system, wherein the voltage regulator device is configured to adjust an amplitude of the regulated voltage at a rate less than or equal to the maximum slew rate.

In some aspects, the techniques described herein relate to a system, wherein adjusting the maximum slew rate of the regulated voltage includes increasing the maximum slew rate as the amplitude of the load current decreases and decreasing the maximum slew rate as the amplitude of the load current increases.

In some aspects, the techniques described herein relate to a system, wherein adjusting the maximum slew rate of the regulated voltage includes: setting the maximum slew rate to a first value based on the amplitude of the load current being less than a first threshold amplitude; and setting the maximum slew rate to a second value less than the first value based on the amplitude of the load current being greater than the first threshold amplitude and less than a second threshold amplitude.

In some aspects, the techniques described herein relate to a system, wherein adjusting the maximum slew rate of the regulated voltage further includes: setting the maximum slew rate to a third value less than the second value based on the amplitude of the load current being greater than the second threshold amplitude and less than a third threshold amplitude; and setting the maximum slew rate to a fourth value less than the third value based on the amplitude of the load current being greater than the third threshold amplitude.

In some aspects, the techniques described herein relate to a system, wherein the slew rate control circuit includes a variable resistor, wherein the maximum slew rate of the regulated voltage is based on a resistance of the variable resistor, and wherein adjusting the maximum slew rate of the regulated voltage includes adjusting the resistance of the variable resistor.

In some aspects, the techniques described herein relate to a system, wherein: the voltage regulator device includes a switching circuit; and adjusting the maximum slew rate of the regulated voltage includes the slew rate control circuit adjusting a maximum rate of change of duty cycles of one or more switches of the switching circuit.

In some aspects, the techniques described herein relate to a voltage regulator device including: a phase circuit configured to provide a power supply signal having a regulated voltage to an integrated circuit; and a slew rate control circuit configured to perform operations including adjusting a maximum slew rate of the regulated voltage based on an amplitude of a load current provided to the integrated circuit.

In some aspects, the techniques described herein relate to a voltage regulator device, wherein the phase circuit is configured to adjust an amplitude of the regulated voltage at a rate less than or equal to the maximum slew rate.

In some aspects, the techniques described herein relate to a voltage regulator device, wherein adjusting the maximum slew rate of the regulated voltage includes: setting the maximum slew rate to a first value based on the amplitude of the load current being less than a first threshold amplitude; and setting the maximum slew rate to a fourth value less than the first value based on the amplitude of the load current being greater than a third threshold amplitude.

In some aspects, the techniques described herein relate to a voltage regulator device, wherein the slew rate control circuit includes a variable resistor, wherein the maximum slew rate of the regulated voltage is based on a resistance of the variable resistor, and wherein adjusting the maximum slew rate of the regulated voltage includes adjusting the resistance of the variable resistor.

In some aspects, the techniques described herein relate to a voltage regulator device, wherein: the phase circuit includes a switching circuit; and adjusting the maximum slew rate of the regulated voltage includes the slew rate control circuit adjusting a maximum rate of change of duty cycles of one or more switches of the switching circuit.

In some aspects, the techniques described herein relate to a voltage regulation method including: providing, by a voltage regulator device to an integrated circuit, a power supply signal having a regulated voltage; and adjusting, by a slew rate control circuit of the voltage regulator device, a maximum slew rate of the regulated voltage, wherein the adjusting is based on an amplitude of a load current provided to the integrated circuit.

In some aspects, the techniques described herein relate to a method, further including: receiving, by the voltage regulator device, a request sent by the integrated circuit, the request indicating a target amplitude of the regulated voltage; and adjusting, by the voltage regulator device, the regulated voltage from a first amplitude to the target amplitude at a rate less than or equal to the maximum slew rate.

In some aspects, the techniques described herein relate to a method, wherein the integrated circuit includes a central processing unit (CPU), graphics processing unit (GPU), or accelerated processing unit (APU).

In some aspects, the techniques described herein relate to a method, further including adjusting, by the voltage regulator device, an amplitude of the regulated voltage at a rate less than or equal to the maximum slew rate.

In some aspects, the techniques described herein relate to a method, wherein adjusting the maximum slew rate of the regulated voltage includes: setting the maximum slew rate to a first value based on the amplitude of the load current being less than a first threshold amplitude; and setting the maximum slew rate to a second value less than the first value based on the amplitude of the load current being greater than the first threshold amplitude and less than a second threshold amplitude.

In some aspects, the techniques described herein relate to a method, wherein adjusting the maximum slew rate of the regulated voltage further includes adjusting the first value of the maximum slew rate, the second value of the maximum slew rate, the first threshold amplitude, and/or the second threshold amplitude based on data indicating (1) attributes of an environment of the voltage regulator device or integrated circuit, (2) an age of the voltage regulator device or integrated circuit, (3) historical usage of the voltage regulator device or integrated circuit, and/or (4) attributes of past performance of the integrated circuit.

FIG. 1 illustrates one exemplary implementation of a computer system 100 configured to implement the techniques described herein, although others are possible. It should be appreciated that FIG. 1 is intended neither to be a depiction of necessary components for a computer system 100 to operate in accordance with the principles described herein, nor a comprehensive depiction.

Computer system 100 can be, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. Computer system 100 can comprise at least one central processing unit (CPU) 102, one or more integrated circuits 103 (e.g., CPU, graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), other processing device, memory, other integrated circuit, etc.), connection circuitry 108, I/O circuitry 110, system memory 126, at least one I/O device 130, at least one accelerator 134, storage 146 (e.g., computer-readable storage media), and/or at least one display 128. In some examples, the CPU 102, integrated circuit(s) 103, connection circuitry 108, and I/O circuitry 110, are coupled to (e.g., mounted on) a printed circuit board (e.g., motherboard) 101.

CPU 102 enables processing of data and execution of instructions. The data and instructions can be stored on system memory 126, storage 146, and/or internal memory (not shown) of the CPU 102. In some examples, the CPU 102 includes one or more processor chiplets 104-1 . . . 104-N, which can be disposed on or over a package substrate 144. In some examples, the processor chiplets can communicate with each other via interconnects routed through or on the package substrate 144 (e.g., through an interposer layer disposed between the package substrate 144 and the processor chiplets). In some examples, each processor chiplet includes one or more cores (106, 108). Different processor chiplets can have the same or different numbers of cores (106, 108). In the example of FIG. 1, processor chiplet 104-1 has K cores 106-1 . . . 106-K, and processor chiplet 104-N has L cores (108-1, 108-2, . . . 108-L). The cores within an individual processor chiplet (e.g., cores 106-1 . . . 106-K) can be homogeneous or heterogeneous. Likewise, the cores on different processor chiplets (e.g., cores 106-1 and 108-1) can be homogeneous or heterogeneous.

In the example of FIG. 1, the CPU 102 is configured to execute instructions of an operating system 142 and/or instructions (e.g., program code 140) of one or more applications. In some examples, the functionality of the program code can be implemented by one or more integrated circuits 103, one or more CPUs 102, one or more processor chiplets of a CPU 102, and/or one or more cores of a processor chiplet.

The data and instructions stored on any of the computer-readable storage media (e.g., system memory 126, storage 146, accelerator memory 138, internal or external caches of the CPU 102, etc.) can comprise computer-executable instructions implementing any suitable functionality.

In some examples, connection circuitry 108 communicatively couples CPUs 102 with each other, with integrated circuit(s) 103, and/or with external caches (e.g., level-2 (L2) cache, level-3 (L3) cache, etc.). Additionally or alternatively, the connection circuitry 108 can communicatively couple the CPUs 102 with I/O circuitry 110, which communicatively couples system memory, storage devices, and peripheral devices to each other and (via the connection circuitry 108) to the CPUs 102. The connection circuitry can couple the CPUs 102, external caches, and I/O circuitry 110 using any suitable network topology (e.g., a front-side bus, a back-side bus, etc.), and the coupled components can send and receive messages via the connection circuitry using any suitable communication protocol. In some examples, portions of the connection circuitry 108 can be integrated into the CPU(s) 102 and/or integrated circuit(s) 103.

In some examples, I/O circuitry 110 includes one or more memory controllers 112, one or more storage connectors 120, display circuitry 118, one or more peripheral connectors 124, and a peripheral switch 122. The memory controller(s) 112 can be configured to control the flow of data to and from the system memory 126. The storage connector(s) 120 can be configured to control the flow of data to and from the storage 146. The display circuitry 118 can be configured to send visual data (e.g., user interface data, image data, video data, etc.) to the display 128, which can be configured to display the visual data. In some examples, the display circuitry 118 can also be configured to receive data representing user input from the display 128 (e.g., in cases where the display 128 includes a touchscreen). In some examples, portions of the I/O circuitry 110 can be integrated into a motherboard and/or motherboard chipset (e.g., I/O circuitry 110) of the computer system 100.

Each of the peripheral connectors 124 can be configured to physically connect and communicatively couple the I/O circuitry 110 to a peripheral device. Any suitable type of peripheral device can be connected to a peripheral connector 124 including, without limitation, an I/O device 130 (e.g., an input device, output device, or input/output device), an accelerator 134, etc. Some non-limiting examples of an input device can include a mouse, keyboard, scanner, video game controller, microphone, webcam, etc. Some non-limiting examples of an output device can include a display, printer, speakers, headphones, earbuds, etc. Some non-limiting examples of an input/output device can include a storage device (e.g., disk drive, solid-state drive, universal serial bus (USB) flash drive, memory card, tape drive, etc.), a networking device (e.g., modem, router, gateway, network adapter, access point, etc.), etc. A networking adapter can be any suitable hardware and/or software to enable the computer system 100 to communicate via wires and/or wirelessly with any other suitable computing system over any suitable computing network. The computing network can include wireless access points, switches, routers, gateways, and/or other networking equipment as well as any suitable wired and/or wireless communication medium or media for exchanging data between two or more computers, including the Internet. Optionally, an I/O device can include one or more registers 132. In some examples, the I/O circuitry 110 can control the operation of an I/O device 130 by writing suitable data to one or more of the I/O device's registers, and/or can monitor the status of an I/O device 130 by reading the contents of one or more of the I/O device's registers.

Some non-limiting examples of an accelerator 134 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc. In some examples, an accelerator 134 includes one or more registers 136 and memory 138. In some examples, the I/O circuitry 110 can control the operation of an accelerator 134 by writing suitable data to one or more of the accelerator's registers, and/or can monitor the status of an accelerator 134 by reading the contents of one or more of the accelerator's registers.

The peripheral switch 122 can be configured to switch packets sent to or from the peripheral devices. Any suitable type of peripheral connector(s) 124 and peripheral switch 122 can be used including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc.

As described above computer system 100 can have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

In some examples, computer system 100 further includes a voltage regulator 160. In some examples, the voltage regulator 160 receives power supply signals 152 (e.g., unregulated or insufficiently regulated power supply signals) from a power supply 150, and provides, via conductive couplings 184 (e.g., 184a, 184b, 184c), supply signal(s) with regulated voltage(s) to CPU(s) 102, integrated circuit(s) 103, I/O circuitry 110, any other components of the computer system 100, or any subset thereof. In some examples, the power supply 150 is a direct current (DC) power supply, and the signals provided by the power supply 150 are DC power supply signals 152. Some non-limiting examples of power supplies 150 can include one or more batteries (e.g., rechargeable batteries), an alternating current (AC) to DC power adapter (e.g., a power adapter for a mobile computing device), etc. In some examples, the voltage regulator 160 includes a voltage regulator (VR) controller 170 and an adaptive voltage regulator (VR) device 180. In some examples, the VR controller 170, the adaptive VR device 180, both components, or neither component is physically attached to (e.g., mounted on) a motherboard of computer system 100.

In some examples, the VR controller 170 of the voltage regulator 160 is configured to control the operation of the adaptive VR device 180. For example, the VR controller 170 can control the number of regulated supply signals provided by the adaptive VR device 180 (up to a maximum number of regulated supply signals that the adaptive VR device 180 is capable of providing), the amplitudes of the voltages and/or currents of the regulated supply signals, etc. In some examples, the VR controller 170 controls the adaptive VR device 180 by providing one or more control signals 172 to the VR device 180. Such control signals 172 can include one or more power supply signals (e.g., with voltages determined by the VR controller 170), signals controlling the operation of transistors in the power stages of the adaptive VR device 180 (e.g., pulse-width modulated (PWM) signals controlling the duty cycles of such transistors), etc. In some examples, the VR controller 170 controls the adaptive VR device 180 based on feedback signals 182 from the adaptive VR device 180 indicating values of one or more parameters of the adaptive VR device 180. Some non-limiting examples of such parameters can include temperature(s) sensed by the VR device, voltages and/or currents of signals within the adaptive VR device 180 or produced by the adaptive VR device 180 (including the regulated supply signals), etc.

In some examples, the adaptive VR device 180 of the voltage regulator 160 is configured to provide one or more regulated power supply signals to one or more components of the computer system 100. The adaptive VR device 180 can provide each regulated power supply signal with voltage of any suitable amplitude (e.g., 1 μV to 120 V) and/or current of any suitable amplitude (e.g., 1 μA-500 A). In some examples, the adaptive VR device 180 is electrically coupled to one or more components of the computer system 100 via the printed circuit board 101 (e.g., motherboard), and the regulated power supply signals are provided to the components of the computer system via traces, wires, or other conductive couplings 184 of the printed circuit board. In some examples, the adaptive VR device 180 includes one or more sensors (e.g., voltage sensors, current sensors, temperature sensors, etc.) operable to sense values of one or more parameters of the adaptive VR device 180. In some examples, the adaptive VR device can adapt its operation based on those sensed values and/or communicate those sensed values to the VR controller 170 via monitoring signals 182.

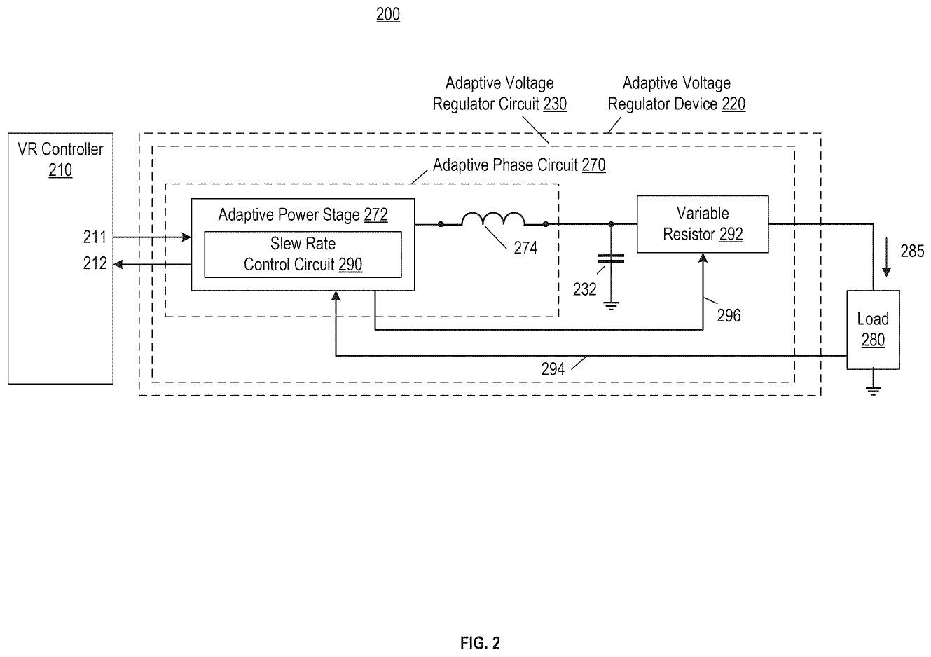

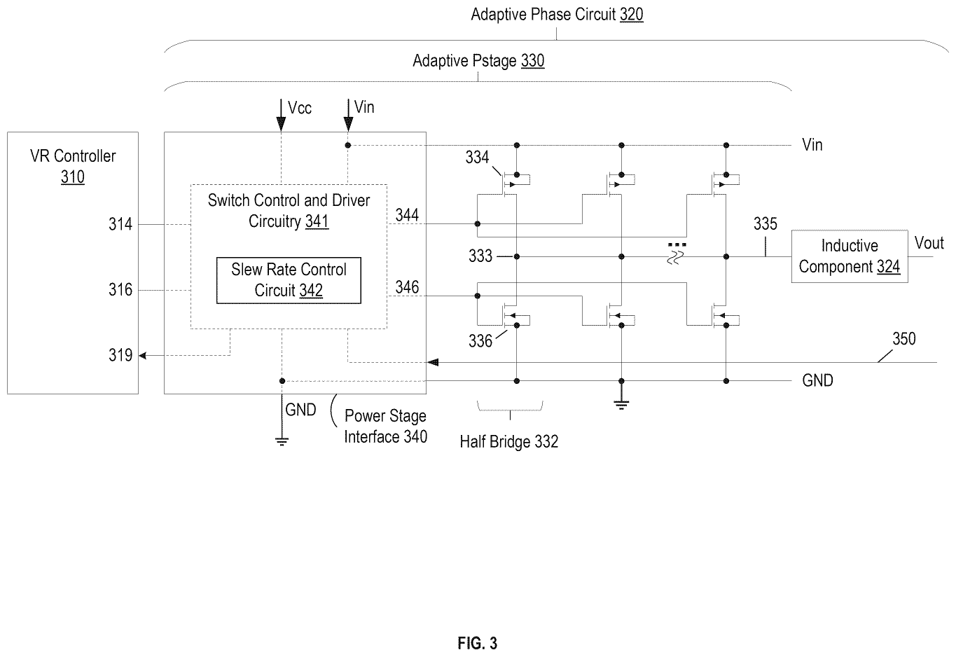

In some examples, the adaptive VR device 180 includes one or more slew rate control circuits 181 configured to control the slew rates of the voltages of the power supply signal(s) provided by the adaptive VR device 180. In some examples, a slew rate control circuit 181 sets the maximum permissible slew rate of the voltage of a corresponding power supply signal, and controls the operation of the adaptive VR device 180 such that the actual slew rate of the power supply signal does not exceed the maximum permissible slew rate. The “actual slew rate” of the power supply signal can refer to an instantaneous slew rate (e.g., an instantaneous rate of change of the regulated power supply signal voltage at any time) or an average slew rate (e.g., an average rate of change of the regulated power supply signal voltage over any suitable time period). Described below, with reference to FIGS. 2 and 3, are some non-limiting examples of implementations of the slew rate control circuit(s) 181 and some non-limiting examples of techniques the slew rate control circuit(s) 181 can use (1) to set the maximum permissible slew rate of the voltage of a corresponding power supply signal and/or (2) to control the operation of the adaptive VR device 180 such that the actual slew rate of the corresponding power supply signal does not exceed the maximum permissible slew rate.

In some examples, the adaptive VR device 180 can change the maximum permissible slew rate of the power supply signal(s). For example, the adaptive VR device 180 can change the maximum permissible slew rate of the voltage a power supply signal based on the amplitude of the current provided to a load (e.g., the current delivered to an integrated circuit 103 by the power supply signal). As just one example, the adaptive VR device 180 can increase the maximum permissible slew rate of the voltage of a power supply signal as the load current decreases and increase the maximum permissible slew rate of the voltage of the power supply signal as the load current increases.

In some examples, a load (e.g., integrated circuit 103) can send a message to the voltage regulator 160 (e.g., to adaptive VR device 180) requesting (e.g., instructing) the voltage regulator 160 to set the regulated voltage of the power supply signal to a target voltage. In some examples, the message includes data indicating the target voltage (e.g., data identifying the target voltage, or data identifying a VR state corresponding to the target voltage). In some examples, the load encodes the message according to the Voltage Identification (VID) protocol. For example, the load can send an N-bit (e.g., 6-bit) VID code representing the target voltage. In some examples, based on the receipt of a message requesting that the regulated voltage of the power supply signal be set to a target value, the voltage regulator 160 (e.g., the adaptive VR device 180) adjusts the regulated voltage from its pre-existing amplitude to the target amplitude at a rate less than or equal to the maximum slew rate.

FIG. 2 illustrates one example implementation of a voltage regulator 200 (e.g., voltage regulator 160). In some examples, the voltage regulator 200 includes a VR controller 210 (e.g., VR controller 170) and an adaptive VR device 220 (e.g., adaptive VR device 180). In some examples, the adaptive VR device 220 includes an adaptive voltage regulator (VR) circuit 230. The adaptive VR circuit 230 can be configured to provide a power supply signal 285 to a load 280 (e.g., an integrated circuit 103), to set the maximum slew rate of the regulated voltage of the power supply signal 285, and to control the slew rate of the power supply signal's regulated supply voltage in accordance with the maximum slew rate setting.

In some examples, the adaptive VR circuit 230 includes an adaptive phase circuit 270 (sometimes referred to as an “adaptive phase”) and a capacitive component 232 (e.g., a capacitor). The adaptive phase circuit 270 can include an adaptive power stage 272 and an inductive component 274 (e.g., a linear or non-linear inductor). The adaptive power stage 272 can include one or more switches (e.g., MOSFETs or other transistors) and switch control and driver circuitry operable to control the amount of power (or current) provided by the adaptive phase circuit 270 to the load 280 by selectively activating and deactivating the switches. In some examples, the adaptive power stage 272 further includes a slew rate control circuit 290 (e.g., slew rate control circuit 181). Some non-limiting example implementations of the slew rate control circuit 290 are described below. The adaptive power stage 272 can have any suitable configuration or topology. Some non-limiting examples of adaptive power stages 272 are described herein with reference to FIG. 3.

In some examples, the adaptive VR circuit 230 further includes a variable resistor 292, which can be coupled between the capacitive component 232 and the VR circuit's load 280, or in any other suitable location along the conductive path between the adaptive power stage 272 and the load 280. In some examples, the variable resistor 292 is configured to limit the maximum slew rate of the voltage of the power supply signal 285.

In some examples, the adaptive phase circuit 270 is capable of providing current with a range of amplitudes to the load 280. For example, the adaptive phase circuit 270 can be configured to provide current with an amplitude between 500 mA and 50 A. In some examples, the VR controller 210 provides control signals 211 to control the operation of the adaptive phase circuit 270. In some examples, the adaptive phase circuit 270 provides feedback signals 212 to the VR controller 210. Such feedback signals can indicate the values of parameters of the adaptive phase circuit, and the VR controller 210 can set or adjust the control signals 211 provided to the adaptive phase circuit 270 based on the feedback signals 212 received from the adaptive phase circuit 270.

The inductive component 274 of the adaptive phase circuit 270 can be coupled between the phase circuit's adaptive power stage 272 and a terminal of the capacitive component 232. The combination of the adaptive phase circuit's inductive component 274 and the adaptive VR circuit's capacitive component 232 can form a filter that reduces ripple voltage and/or ripple current of the power supply signal 285 provided by the adaptive VR circuit 230 to the load 280. In addition, the combination of the adaptive phase circuit 270 and the adaptive VR circuit's capacitive component 232 can form a DC-to-DC converter (e.g., a buck converter, boost converter, buck-boost converter, cuk converter, etc.). The DC-to-DC converter can be configured to operate in a continuous mode and/or in a discontinuous mode. In some examples, the inductive component 274 is a linear inductor having a relatively low inductance (e.g., less than 100 nH), a moderate inductance (e.g., 100-500 nH), or a high inductance (e.g., greater than 500 nH). In some examples, the inductive component 274 is a non-linear inductor having an inductance that varies (e.g., between 100 nH and 500 nH) based on operating conditions.

In some examples, the slew rate control circuit 290 (e.g., slew rate control circuit 181) controls the slew rate of the regulated voltage of the power supply signal 285 provided by the adaptive VR device 220 to the load 280. In some examples, the slew rate control circuit 290 sets the maximum permissible slew rate of the regulated voltage of the power supply signal 285. The slew rate control circuit can set (or change) the maximum permissible slew rate based on any suitable data. For example, the slew rate control circuit 290 can set the maximum permissible slew rate of the regulated voltage of the power supply signal 285 based on the amplitude of the current provided to the load 280 (e.g., the current delivered to the load 280 by the power supply signal 285). As just one example, the adaptive VR device 180 can increase the maximum permissible slew rate of the voltage of the power supply signal 285 as the load current decreases and increase the maximum permissible slew rate of the power supply signal 285 as the load current increases. Some non-limiting examples of techniques for sensing the amplitude of the load current delivered by the adaptive phase circuit 270 are described below with reference to FIG. 3.

The slew rate control circuit 290 can set the maximum permissible slew rate of the regulated voltage of the power supply signal 285 using any suitable circuits and/or techniques. In some examples, the adaptive VR circuit 230 includes a variable resistor 292, and the slew rate control circuit 290 sets the maximum slew rate by adjusting the resistance of the variable resistor 292, thereby adjusting the time constant of the RLC circuit formed by inductive component 274, capacitive component 232, and variable resistor 292. In some examples, variable resistor 292 includes one or more transistors (e.g., MOSFETs), and the slew rate control circuit 290 adjusts the resistance of the variable resistor 292 by adjusting the bias voltages 296 applied to the terminals of the transistor(s), thereby adjusting the operating point(s) and channel resistance(s) of the transistor(s). A non-limiting example of an additional or alternative technique for setting the maximum permissible slew rate of the regulated voltage of the power supply signal 285 is described below with reference to FIG. 3.

In some examples, the load 280 can send a message 294 to the slew rate control circuit 290 requesting (e.g., instructing) the adaptive VR device 220 to set the regulated voltage of the power supply signal to a target voltage. In some examples, the message includes data indicating the target voltage. In some examples, the load 280 encodes the message according to the Voltage Identification (VID) protocol. In some examples, based on the receipt of a message requesting that the regulated voltage of the power supply signal be set to a target value, the adaptive VR circuit 230 adjusts the regulated voltage from its pre-existing amplitude to the target amplitude at a rate less than or equal to the maximum slew rate. With the resistance of the variable resistor 292 adjusted to a value corresponding to the maximum permissible slew rate, the RLC circuit of the adaptive VR circuit 230 can control the operation of the adaptive VR circuit 230 such that the actual slew rate of the regulated voltage does not exceed the maximum permissible slew rate.

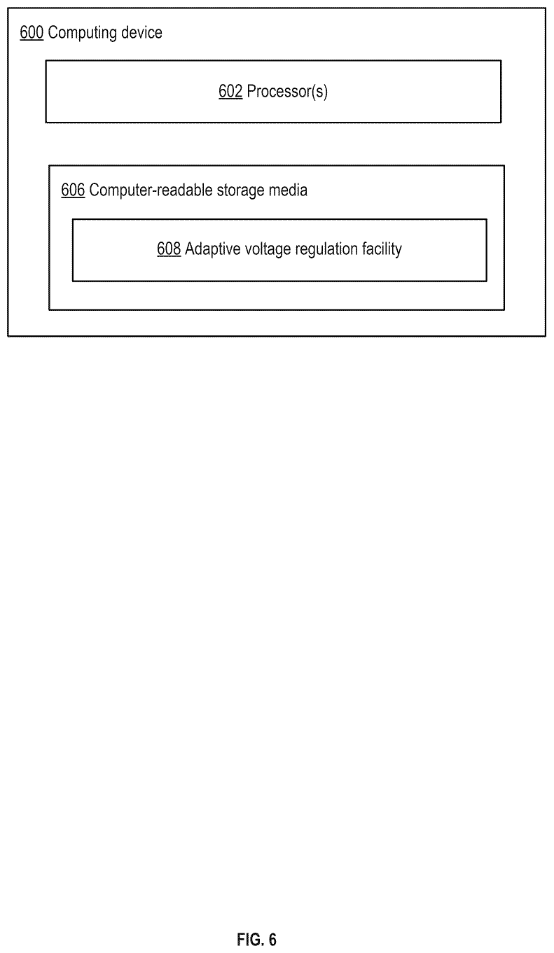

The slew rate control circuit 290 can be implemented using any suitable circuits or techniques. In some examples, the slew rate control circuit 290 includes a computing device configured or programmed (e.g., with software or firmware) to set the maximum permissible slew rate of the regulated voltage of the power supply signal as described herein. Some non-limiting examples of computing devices configured to implement the slew rate control circuit 290 are described below with reference to FIG. 6.

An example has been described in which the slew rate control circuit 290 is a component of the adaptive power stage 272 of an adaptive phase circuit 270, and the variable resistor 292 is a component of the adaptive VR circuit 230. In some examples, the slew rate control circuit 290 is a component of the VR controller 210. Alternatively, the slew rate control circuit 290 can be a component of the adaptive VR device circuit 230, separate from the adaptive power stage 272. In some examples, the variable resistor is a component of the adaptive phase circuit 270 (e.g., coupled between the adaptive power stage 272 and the inductive component 274, or between the inductive component 274 and the capacitive component 232).

In the example of FIG. 2, the a single adaptive VR circuit 230 and a single adaptive phase circuit 270 are depicted. However, the adaptive VR device 220 can include one or more VR circuits (e.g., one or more adaptive phase circuits), and each adaptive VR circuit can include one or more phase circuits (e.g., one or more adaptive phase circuits). In an adaptive VR circuit 230 having two or more phase circuits, the inductive component of each adaptive phase circuit can be coupled between the power stage of the adaptive phase circuit and the capacitive component 232 of the adaptive VR circuit 230. In an adaptive VR device 220 having two or more VR circuits, each VR circuit can provide a distinct regulated power supply signal to a distinct load. In a voltage regulator 200 in which the slew rate control circuit 290 is a component of the VR controller 210, the VR controller 210 can include one slew rate control circuit 290 per adaptive VR circuit 230 or one slew rate control circuit 290 per adaptive phase circuit 270.

FIG. 3 illustrates one exemplary implementation of an adaptive power stage (Pstage) of an adaptive phase circuit 320. Other implementations of the adaptive power stage 330 are possible. In some examples, the adaptive phase circuit 320 also includes an inductive component 324.

In some examples, an adaptive power stage 330 includes one or more high-side switches 334 (e.g., p-type MOSFETs) configured to couple the switch node 335 of the adaptive power stage to a supply voltage rail (Vin) (thereby delivering power and/or current to the switch node 335), and one or more low-side switches 336 (e.g., n-type MOSFETs) configured to couple the switch node 335 of the adaptive power stage to ground (GND) (thereby delivering power and/or current from the switch node 335 to ground). In some examples, pairs of high-side switches 334 and low-side switches 336 are connected in a half bridge configuration, with the conducting path (e.g., channel) of the high-side switch 334 coupled between the supply voltage rail (Vin) and the half bridge's switch node 333, and the conducting path (e.g., channel) of the low-side switch 336 coupled between the half bridge's switch node 333 and ground (GND). The adaptive power stage 330 can include one or more half bridges 332, with their switch nodes 333 coupled to each other and to the switch node 335 of the adaptive power stage. Other arrangements of the high- and low-side switches are possible.

In some examples, the adaptive power stage 330 further includes power stage interface 340. In some examples, the power stage interface 340 includes switch control and driver circuitry 341. In some examples, the power stage interface 340 receives power supply signals (e.g., supply voltage Vin, power supply bias voltage Vcc, and ground reference GND) from a power supply, and provides those power supply signals to the switch control and driver circuitry 341 and to the switches (334, 336) of the adaptive power stage 330. In some examples, the power stage interface 340 receives control signals 314 and 316 from the VR controller 310. In some examples, the control signals (314, 316) indicate the amount of power (or current) to be delivered to the adaptive power stage's switch node 335, or delivered from the adaptive power stage's switch node 335 to ground. In some examples, the control signals (314, 316) indicate the duty cycles at which the switches (334, 336) of the adaptive power stage 330 are to be operated. The power stage interface 340 can provide the control signals (314, 316) as inputs to the switch control and driver circuitry 341. In some examples, the switch control and driver circuitry 341 generates control signals (344, 346) for the adaptive power stage 330 based on the control signals (314, 316) provided by the VR controller 310. In some examples, the control signals 344 (e.g., pulse-width modulated (PWM) control signals) are provided to the control terminals (e.g., gates) of the high-side switches 334, such that the control signals 344 determine the duty cycles of the high-side switches 334. In some examples, the control signals 346 (e.g., pulse-width modulated (PWM) control signals) are provided to the control terminals (e.g., gates) of the low-side switches 336, such that the control signals 346 determine the duty cycles of the low-side switches 336.

In some examples, the power stage interface 340 provides one or more feedback signals 319 to the VR controller 310. The feedback signal(s) can indicate the values of one or more parameters of the adaptive power stage 330. Some non-limiting examples of such parameters can include a temperature of the adaptive power stage 330, voltages and/or currents of one or more signals within the adaptive power stage 330 or produced by the adaptive power stage 330 (e.g., the amplitude of the current delivered to switch node 335, etc.). The feedback signals can be provided by the switch control and driver circuitry 341. In some examples, the switch control and driver circuitry 341 includes current sensing circuitry that senses the amplitudes of one or more currents in the adaptive power stage 330 (e.g., the current at switch node 335, the currents flowing through each of the half bridges 332, etc.) and provides the feedback signal(s) 319 indicating the amplitudes of the sensed current(s). In some examples, the power stage interface 340 includes a temperature sensor, which provides a feedback signal 319 indicating the temperature of the adaptive power stage 330. In some examples, the power stage interface 340 receives messages 350 (e.g., messages 294) from a load (e.g., load 280) requesting (e.g., instructing) the adaptive VR device 220 to set the regulated voltage of the power supply signal to a target voltage, and provides those messages (or data derived therefrom) to the VR controller 310 as feedback signals 319.

In some examples, the switch control and driver circuitry 341 includes a slew rate control circuit 342. In some examples, the slew rate control circuit 342 can adjust the maximum permissible slew rate of the regulated voltage of the power supply signal delivered to switch node 335 by adjusting a maximum rate at which the duty cycles of the switches (334, 336) of the adaptive power stage 330 are permitted to change. In some examples, the slew rate control circuit 342 can control the maximum rate at which the duty cycles of the switches (334, 336) are permitted to change by controlling the duty cycles of pulse-width modulated control signals (e.g., control signals 344, 346) provided to the switches. In some examples, the slew rate control circuit 342 can also control the maximum permissible slew rate of the regulated voltage of the power supply signal by setting the resistance of a variable resistor 292, as described above in connection with FIG. 2.

FIG. 4 illustrates one example of an adaptive voltage regulation method 400. In some examples, the method 400 can be performed by a voltage regulator 200 or components thereof. In some examples, the method 400 includes steps 410-430, each of which is described in further detail below.

In step 410, the voltage regulator device provides a power supply signal having a regulated voltage to a load. The load can include a central processing unit (CPU), graphics processing unit (GPU), accelerated processing unit (APU), and/or any other suitable integrated circuit. Some non-limiting examples of techniques for providing a power supply signal having a regulated voltage to a load are described herein.

In step 420, the voltage regulator device adjusts a maximum permissible slew rate of the regulated voltage of the power supply signal. This adjustment (e.g., the adjusted value of the maximum permissible slew rate, the decision to adjust the value of the maximum permissible slew rate, etc.) can be based on any suitable data. For example, the adjustment can be based on an amplitude of a current provided to the load by the voltage regulator device, by a VR circuit thereof, or by a phase circuit thereof. Some non-limiting examples of techniques for sensing the current provided to the load are described herein.

In some examples, the VR device adjusts the maximum permissible slew rate of the regulated voltage of the power supply signal in accordance with the adjustment scheme illustrated in FIG. 5. In the example of FIG. 5, the maximum permissible slew rate of the regulated voltage (dv/dt) is set to a first value (dv/dt₁) when the amplitude of the current provided to the load is less than a first threshold value (I_{THRESH1}), set to a second value (dv/dt₂) lower than the first value (dv/dt₁) when the amplitude of the current provided to the load is greater than or equal to the first threshold value (I_{THRESH1}) and less than a second threshold value (I_{THRESH2}), set to a third value (dv/dt₃) lower than the second value (dv/dt₂) when the amplitude of the current provided to the load is greater than or equal to the second threshold value (I_{THRESH2}) and less than a third threshold value (I_{THRESH3}), and set to a fourth value (dv/dt₄) lower than the second value (dv/dt₃) when the amplitude of the current provided to the load is greater than or equal to the third threshold value (I_{THRESH3}). More generally, the maximum permissible slew rate of the regulated voltage can be determined based on any suitable discrete or continuous function of the load current. Still more generally, the adjustment of the maximum permissible slew rate is not limited to the scheme illustrated in FIG. 5. Some non-limiting examples of circuits and techniques for setting the maximum permissible slew rate to a specified value are described herein.

In the example of FIG. 5, the VR device is configured to adjust the maximum permissible slew rate of the regulated voltage among four possible settings (e.g., “slew rate regions”). However, the example of FIG. 5 is not limiting. In some examples, the VR device is configured to adjust the maximum permissible slew rate of the regulated voltage among any suitable number of slew rate regions (e.g., 2 regions, 3 regions, 4 regions, 5 regions, 6-10 regions, 10-15 regions, etc.) corresponding to any suitable number of thresholds relating to the amplitude of the load current. In some examples, the VR device is configured to adjust (e.g., increase or decrease) the number of slew rate regions, the thresholds defining the boundaries of each slew rate region, and/or the maximum permissible slew rate of the regulated voltage within each slew rate region. Such adjustments can be based on user input and/or any suitable data. For example, such adjustments can be based on data indicating (1) attributes of the system's environment (e.g., temperature, humidity, etc.), (2) the age of the system or components thereof, (3) historical usage of the system or components thereof, (4) attributes of the system's past performance (e.g., while operating in one or more of the slew rate regions), etc. Adjustments based on the system's environment, age, and/or historical usage can help the voltage regulator respond and adapt to changes in the operation of the system's components, whether those changes are induced by changes in the environment, the passage of time, or wear and tear. Adjustments based on the system's past performance can help the voltage regulator customize its operation based on the actual, observed performance of the system under real-world conditions, rather than adhering to a predetermined, “one-size-fits-all” slew rate control scheme that attempts to account for many possible sources of variance in the performance of a large set of systems.

Referring again to FIG. 4, in step 430, the VR device adjusts the amplitude of the regulated voltage at a rate less than or equal to the maximum permissible slew rate. In some examples, this adjustment is initiated based on receipt of a message from the load, requesting that the amplitude of the regulated voltage be set to a target value. More generally, this adjustment can be initiated based on the workload of the load and/or based on any other suitable data, and the target value of the regulated voltage can be set based on any suitable data.

Techniques operating according to the principles described herein can be implemented in any suitable manner. Included in the discussion above is a flow chart showing the steps and acts of an adaptive voltage regulation process. The processing and decision blocks of the flow chart above represent steps and acts that can be included in algorithms that carry out this process. Algorithms derived from this process can be implemented as software integrated with and directing the operation of one or more single-or multi-purpose processors, can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flow chart included herein does not depict the syntax or operation of any particular circuit or of any particular programming language or type of programming language. Rather, the flow chart illustrates the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in the flow chart is merely illustrative of the algorithms that can be implemented and can be varied in implementations and embodiments of the principles described herein.

Accordingly, in some examples, the techniques described herein can be embodied in computer-executable instructions implemented as software, including as system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative examples, be adapted to interact with other, unrelated functional facilities and/or processes, to implement a software program application.

Some exemplary functional facilities are described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some examples, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as computer-readable storage media 606 of FIG. 6 described below (i.e., as a portion of a computing device 600) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

In some, but not all, implementations in which the techniques can be embodied as computer-executable instructions, these instructions can be executed on one or more suitable computing device(s) operating in any suitable computer system, including the exemplary computer system of FIG. 1, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 6 illustrates one exemplary implementation of a computing device in the form of a computing device 600 that can be used in a system implementing the techniques described herein, although others are possible. It should be appreciated that FIG. 6 is intended neither to be a depiction of necessary components for a computing device to operate in accordance with the principles described herein, nor a comprehensive depiction.

Computing device 600 can comprise at least one processor 602 and computer-readable storage media 606. Computer-readable media 606 can be adapted to store data to be processed and/or instructions to be executed by one or more processors 602. Processor 602 enables processing of data and execution of instructions. The data and instructions can be stored on the computer-readable storage media 606.

The data and instructions stored on computer-readable storage media 606 can comprise computer-executable instructions implementing techniques which operate according to the principles described herein. In the example of FIG. 6, computer-readable storage media 606 stores computer-executable instructions implementing various facilities and storing various information as described above. Computer-readable storage media 606 can store an adaptive voltage regulation facility 608 configured to perform the steps of an adaptive voltage regulation method 400.

Examples have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, examples can be constructed in which acts are performed in an order different than illustrated, which can include performing some acts simultaneously, even though shown as sequential acts in illustrative examples.

Various aspects of the examples described above can be used alone, in combination, or in a variety of arrangements not specifically discussed in the examples described in the foregoing and is therefore not limited in its application to the details and arrangement of components set forth in the foregoing description or illustrated in the drawings. For example, aspects described in one example can be combined in any manner with aspects described in other examples.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within ±20%, ±10%, or ±5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A system comprising:
an integrated circuit; and
a voltage regulator device configured to provide a power supply signal having a regulated voltage to the integrated circuit,
wherein the voltage regulator device includes a slew rate control circuit configured to perform operations including adjusting a maximum slew rate of the regulated voltage based on an amplitude of a load current provided to the integrated circuit.

2. The system of claim 1, wherein the integrated circuit is configured to send, to the voltage regulator device, a request indicating a target amplitude of the regulated voltage, and wherein the voltage regulator device is configured to respond to the request by adjusting the regulated voltage from a first amplitude to the target amplitude at a rate less than or equal to the maximum slew rate.

3. The system of claim 2, wherein the integrated circuit comprises a central processing unit (CPU), graphics processing unit (GPU), or accelerated processing unit (APU).

4. The system of claim 1, wherein the voltage regulator device is configured to adjust an amplitude of the regulated voltage at a rate less than or equal to the maximum slew rate.

5. The system of claim 4, wherein adjusting the maximum slew rate of the regulated voltage includes increasing the maximum slew rate as the amplitude of the load current decreases and decreasing the maximum slew rate as the amplitude of the load current increases.

6. The system of claim 4, wherein adjusting the maximum slew rate of the regulated voltage includes:
setting the maximum slew rate to a first value based on the amplitude of the load current being less than a first threshold amplitude; and
setting the maximum slew rate to a second value less than the first value based on the amplitude of the load current being greater than the first threshold amplitude and less than a second threshold amplitude.

7. The system of claim 6, wherein adjusting the maximum slew rate of the regulated voltage further includes:
setting the maximum slew rate to a third value less than the second value based on the amplitude of the load current being greater than the second threshold amplitude and less than a third threshold amplitude; and
setting the maximum slew rate to a fourth value less than the third value based on the amplitude of the load current being greater than the third threshold amplitude.

8. The system of claim 1, wherein the slew rate control circuit includes a variable resistor, wherein the maximum slew rate of the regulated voltage is based on a resistance of the variable resistor, and wherein adjusting the maximum slew rate of the regulated voltage includes adjusting the resistance of the variable resistor.

9. The system of claim 1, wherein:
the voltage regulator device includes a switching circuit; and
adjusting the maximum slew rate of the regulated voltage includes the slew rate control circuit adjusting a maximum rate of change of duty cycles of one or more switches of the switching circuit.

10. A voltage regulator device comprising:
a phase circuit configured to provide a power supply signal having a regulated voltage to an integrated circuit; and
a slew rate control circuit configured to perform operations including adjusting a maximum slew rate of the regulated voltage based on an amplitude of a load current provided to the integrated circuit.

11. The voltage regulator device of claim 10, wherein the phase circuit is configured to adjust an amplitude of the regulated voltage at a rate less than or equal to the maximum slew rate.

12. The voltage regulator device of claim 11, wherein adjusting the maximum slew rate of the regulated voltage includes:
setting the maximum slew rate to a first value based on the amplitude of the load current being less than a first threshold amplitude; and
setting the maximum slew rate to a fourth value less than the first value based on the amplitude of the load current being greater than a third threshold amplitude.

13. The voltage regulator device of claim 11, wherein the slew rate control circuit includes a variable resistor, wherein the maximum slew rate of the regulated voltage is based on a resistance of the variable resistor, and wherein adjusting the maximum slew rate of the regulated voltage includes adjusting the resistance of the variable resistor.

14. The voltage regulator device of claim 11, wherein:
the phase circuit includes a switching circuit; and
adjusting the maximum slew rate of the regulated voltage includes the slew rate control circuit adjusting a maximum rate of change of duty cycles of one or more switches of the switching circuit.

15. A voltage regulation method comprising:
providing, by a voltage regulator device to an integrated circuit, a power supply signal having a regulated voltage; and
adjusting, by a slew rate control circuit of the voltage regulator device, a maximum slew rate of the regulated voltage, wherein the adjusting is based on an amplitude of a load current provided to the integrated circuit.

16. The method of claim 15, further comprising:
receiving, by the voltage regulator device, a request sent by the integrated circuit, the request indicating a target amplitude of the regulated voltage; and
adjusting, by the voltage regulator device, the regulated voltage from a first amplitude to the target amplitude at a rate less than or equal to the maximum slew rate.

17. The method of claim 15, wherein the integrated circuit comprises a central processing unit (CPU), graphics processing unit (GPU), or accelerated processing unit (APU).

18. The method of claim 15, further comprising adjusting, by the voltage regulator device, an amplitude of the regulated voltage at a rate less than or equal to the maximum slew rate.

19. The method of claim 18, wherein adjusting the maximum slew rate of the regulated voltage includes:
setting the maximum slew rate to a first value based on the amplitude of the load current being less than a first threshold amplitude; and
setting the maximum slew rate to a second value less than the first value based on the amplitude of the load current being greater than the first threshold amplitude and less than a second threshold amplitude.

20. The method of claim 19, wherein adjusting the maximum slew rate of the regulated voltage further includes adjusting the first value of the maximum slew rate, the second value of the maximum slew rate, the first threshold amplitude, and/or the second threshold amplitude based on data indicating (1) attributes of an environment of the voltage regulator device or integrated circuit, (2) an age of the voltage regulator device or integrated circuit, (3) historical usage of the voltage regulator device or integrated circuit, and/or (4) attributes of past performance of the integrated circuit.
